(19) United States
(12) Patent Application Publication
(10) Pub. No.: US 2013/0130551 A1
(43) Pub. Date: May 23, 2013

(54) Blade and Housing Assembly

(71) Applicants: Peter Mayer, Glen Oaks, NY (US); Max Rosenblatt, Newton, MA (US); Mei Shibata, New York, NY (US)

(72) Inventors: Peter Mayer, Glen Oaks, NY (US); Max Rosenblatt, Newton, MA (US); Mei Shibata, New York, NY (US)

(73) Assignee: ThinkEco, Inc., New York, NY (US)

(21) Appl. No.: 13/301,847

(22) Filed: Nov. 22, 2011

(51) Int. Cl. H01R 27/02; H01R 13/66

(52) U.S. Cl. 439/620.21; 439/651

(57) ABSTRACT

The invention provides an improved method of routing power from a power source such as an AC power source directly to a printed circuit board and then to an appliance that interfaces with one or more appliance claws that are connected directly or indirectly to the circuit board. Various embodiments offer superior durability, manufacturability, and cost-effectiveness. They may also decrease the dimensions, cost, and complexity of a robust assembly.

### FIELD OF THE INVENTION

The present invention relates to assemblies for housing blades and receptacles.

### BACKGROUND OF THE INVENTION

People have been using electricity since the nineteenth century, and each generation has looked for ways to improve the efficiency of this use. By improving efficiency, costs can be reduced and resources can be conserved.

One movement toward increasing efficiency has been to use appliances that work on timers. For example, many homes and offices are equipped with devices that enable users to program target temperatures for their cooling and heating systems based on different times of the day and different days of the week. This allows users to avoid incurring unwanted cooling and heating charges because they may have forgotten to turn the target temperature for a heating or cooling system down or up when not in use.

More recently, inventions have been disclosed that facilitate the monitoring and determination of when electricity drawing devices are likely to be used. These technologies monitor power consumption and look for signature patterns, and using computer technologies can turn power off to plugged in devices thereby draining less electricity when not in use. Examples of these technologies are disclosed in U.S. Patent Publication No. 2010-0070217, which published on Mar. 18, 2010, and U.S. Patent Publication No. 2010-0280978, which published on Nov. 4, 2010. The devices that are disclosed in these published patent applications and that implement the inventions that are described therein are often referred to as outlet monitoring devices.

Outlet monitoring devices are smart devices that have great potential to increase the ability of a user to improve his or her energy efficiency. However, in addition to using innovative software, these technologies must obtain and process information through hardware, which can include printed circuit boards, energy legs, earth redirectors and appliance claws.

When in use, the components of these smart devices can undergo physical stress, and this stress can impair the ability of the devices to function in their intended manner. Therefore, there is a need to develop technologies for reducing the impact of stress on the components of these devices.

### SUMMARY OF THE INVENTION

The present invention is directed toward systems and methods for rendering an assembly more durable. Through one or more of the embodiments of the present invention, a person of ordinary skill in the art can generate a robust blade and housing assembly that is capable of increasing the durability of a smart device that is configured to be connected to an appliance and to a power source at the same time.

According to a first embodiment, the present invention provides an assembly for stabilization of blades, wherein the assembly comprises: (a) a housing, wherein the housing comprises (1) a base, and (2) a cover, wherein the base and the cover form an interior space and extending from the base into the interior space are a first blade stabilization unit and a second blade stabilization unit, wherein the first blade stabilization unit and the second blade stabilization unit are comprised of a non-electrically conductive material; (b) a first energy leg, wherein the first energy leg comprises (1) a first blade that has a first portion that extends to an exterior of the housing and a second portion that extends to the interior space, wherein the first blade is stabilized by the first blade stabilization unit, and (2) a first rail that is connected to the first blade at a first knee; and (c) a second energy leg, wherein the second energy leg comprises (1) a second blade that has a first portion that extends to the exterior of the housing and a second portion that extends to the interior space, wherein the second blade is stabilized by the second blade stabilization unit, and (2) a second rail that is connected to the second blade at a second knee.

According to a second embodiment, the present invention provides an assembly comprising an appliance claw, wherein the appliance claw comprises: (a) a foot, wherein the foot is configured to stabilize the appliance claw; (b) a spine, wherein the spine extends from the foot and has a first height, and the spine forms the first side of a regular or modified prism, a first portion of a second side of the regular or modified prism, and a first portion of a third side of the regular or modified prism; and (c) a wedge, wherein the wedge has a second height, wherein the first height is less than the second height, and the wedge forms a second portion of the second side of the regular or modified prism and a second portion of the third side of the regular or modified prism, and there is an opening between the second side and the third side that is configured to secure a blade. The prism may be open at one or both of its end faces.

According to a third embodiment, the present invention provides an assembly for stabilization of an appliance claw, wherein the assembly comprises a housing, wherein the housing comprises (a) a base; (b) a cover; and (c) an appliance claw, wherein the base and the cover form an interior space and extending from the base into the interior space is a base receptacle socket support and extending into the interior space from the cover is a wedge stabilization unit, wherein the base receptacle socket support and the wedge stabilization unit are aligned.

Through the use of the various embodiments of the systems and methods of the present invention, one may generate more stable devices for connection to sources of electricity and to appliances. These systems may provide sufficient stability and resistance to stress to warrant UL certification (UL Recognized, a certification mark of Underwriters Laboratories).

### BRIEF DESCRIPTION OF THE FIGURES

FIG. 1 is a representation of a front exterior view of a multi-port outlet device.

FIG. 2 is a representation of a rear exterior view of a multi-port outlet device.

FIG. 3 is a representation of an interior view of a base of an assembly of the present invention.

FIG. 4 is a representation of an interior view of a cover of an assembly of the present invention.

FIG. 5 is a representation of an energy leg of the present invention.

FIG. 6 is a representation of a pair of appliance claws of the present invention with a base receptacle socket support.

### DETAILED DESCRIPTION OF THE INVENTION

For the purpose of this specification and appended claims, unless otherwise indicated, all numbers expressing quantities, percentages or proportions of materials, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present application. At the very least, and not as an attempt to limit the application of the doctrine of equivalents to the scope of the claims, each numerical parameter should at least be construed in light of the number of reported significant digits and by applying ordinary rounding techniques.

All ranges disclosed herein are to be understood to encompass any and all subranges subsumed therein. For example, a range of “1 to 10” includes any and all subranges between (and including) the minimum value of 1 and the maximum value of 10, that is, any and all subranges having a minimum value of equal to or greater than 1 and a maximum value of equal to or less than 10, e.g., 5.5 to 10.

It is also noted that, as used in this specification and the appended claims, the singular forms “a,” “an,” and “the,” include plural referents unless expressly and unequivocally limited to one referent.

Reference will now be made in detail to certain embodiments of the application. While the application will be described in conjunction with the illustrated embodiments, it will be understood that the embodiments are not intended to limit the application. On the contrary, the application is intended to cover all alternatives, modifications, and equivalents that may be included within the application as defined by the appended claims.

According to a first embodiment, the present invention provides an assembly for stabilization of blades. A “blade” is a structure that comprises, consists essentially of or consists of an electrically conductive material such as a metal or a metal alloy, including but not limited to bronze, phosphor bronze, brass or copper. In known technologies, when accessing electricity from a power source (e.g., an AC power source), typically a device is connected directly or indirectly to a plug that comprises two blades. In some embodiments of the present invention, the blades are oriented as NEMA 5 series blades that provide access to a power source.

As persons of ordinary skill in the art are aware, often within a plug a grounding pin is associated with a pair of blades. In some embodiments of the present invention, the grounding pin that is associated with the blades that access a power source is part of an earth redirector. An “earth redirector” serves the purpose of grounding the device through a first pin and optionally mechanically stabilizing the device through a second pin. The first pin may be located closer to the blades than the second pin.

The assembly also comprises a housing that is designed to stabilize blades that engage an energy source. In some embodiments, the housing comprises, consists essentially of or consists of an electrically non-conductive material such as plastic, rubber, silicone or a combination thereof. The housing may be formed from a base and a cover that are configured to come together to define an interior space and an exterior. The housing and the cover may engage each other by for example one or more screws and threads, and/or reciprocal male and female mating parts. Preferably, the base and the cover may be reversibly engaged. Parts are considered to be reversibly engaged if they can come together, be separated and come back together without diminishing their integrity or diminishing it only a negligible amount.

The base has one or more openings through which one or more blades may extend. For example a pair of blades may extend through a pair of openings to access openings in an outlet. Optionally, an earth redirector pin may also exit the base through an opening. In some configurations, the base has four openings: two openings for a single pair of blades, a third opening for a first pin of an earth redirector (a grounding pin), and a fourth opening for a second pin (a stabilization pin) of an earth redirector. From the exterior, one of the pins may appear proximal to a pair of blades. However, in some embodiments, the blades are part of an energy leg and the pin is part of an earth redirector, and the energy leg and the earth redirector are separate structures that are not in direct contact with each other within the assembly.

The base may be configured such that for each blade, extending through the base into the interior space there is a blade stabilization unit. For convenience, when there are two blade stabilization units, they may be referred to as a first blade stabilization unit and a second blade stabilization unit. The blade stabilization units may consist of, consist essentially of or comprise a non-electrically conductive material such as plastic, rubber, or silicone or a combination thereof.

Each blade may extend into the interior of the assembly, and a blade stabilization unit for each blade may partially or completely surround the length of the portion of the blade that is in the interior of the housing. The blade stabilization unit is configured to support the portion of the blade that is within the interior space, and its interior surface is preferably the same as, one, two, three or four sides of the surface of the blade, e.g., a rectangular tube. In some embodiments, the blade stabilization unit may surround at least 70%, at least 80%, at least 90% or 100% of the length of one, two, three or four sides of the portion of the blade that extends into the interior space. The blade will typically not extend across the entire interior space of the assembly, e.g., in some embodiments it may extend up to 50%, 40%, 30%, or 20% of the way across the interior space. The blade stabilization unit may be positioned such that when no stress is on the blade, e.g., when it is not engaged with an outlet and the device is not engaged with an appliance plug, the blade stabilization unit does not contact the blade. However, when a stress is put on the blade, the blade may push against one or more of the walls of the blade stabilization unit.

By way of a non-limiting example, in some embodiments the distance between the portion of the blade within the interior space and each side of the blade stabilization unit when the blade is not experiencing an external stress may be less than 2 mm, less than 1 mm, less than 0.5 mm or less than 0.25 mm. In other embodiments, when not in use, i.e., when the device is engaged with neither an energy source nor an appliance plug, or engaged with only one of the energy source or appliance plug, the sides of the blades that are in the interior space of the assembly come into contact with one or two sides of the blade stabilization units.

As noted above, each blade may be part of an energy leg. An energy leg is a structure that is made of an electrically conductive material and provides a means by which current may travel from an outlet to another electrically conductive material, e.g., an input structure at a printed circuit board or a wire of an appliance. The energy leg may comprise, consist essentially of, or consist of one more pieces that have been stamped to form a blade, a knee (also referred to as a fulcrum) and a rail that is connected or transitioned to the blade at the knee. The rail (also referred to as an arm) may be oriented substantially perpendicular to the blade.

For convenience, when there are two energy legs, one energy leg may be referred to as a first energy leg and the other as a second energy leg. Accordingly, the first energy leg may comprise a first blade, a first rail and a first knee, whereas the second energy blade may comprise a second blade, a second rail and a second knee.

In some embodiments, the rail may be omitted. In these cases, the knee may, for example, be connected to a printed circuit board through a cable with quick disconnect.

A first portion of each blade may extend to an exterior of the housing and a second portion of each blade may extend to the interior space. As noted above, in the interior space, some or all of the second portion of each blade may be within a first blade stabilization unit. Also in the interior space are the first and second rails, which are connected to or transition to the second portions of the first and second blades at first and second knees, respectively.

As noted above and as persons of ordinary skill in the art will recognize, the stabilization units are considered to stabilize the blades, regardless of whether they are in contact at any particular time, because they are arranged such that when a stress is imposed on a blade pushing it in the direction of a wall of the stabilization unit, the stabilization unit will exert an equal and opposite force that will prevent the blade from unacceptable bending, twisting or other changes in size, configuration or orientation. This stress may be temporary, e.g., during insertion or removal of the appliance plug from the device or the device from the outlet, or it may be longer lasting e.g., during engagement of the device with either or both of the appliance plug and the outlet.

In some embodiments of the assembly, the first rail is oriented orthogonally to the first blade, and the second rail is oriented orthogonally to the second blade. In some embodiments, the two rails may be positioned as mirror images of each other and part or all of the rails may be parallel to each other. Furthermore in some embodiments, the first rail is riveted to the first blade at the first knee and the second rail is riveted to the second blade at the second knee. By way of further non-limiting examples, the first rail and the second rail may be coplanar with the base or exist in planes that are parallel to the base.

The assembly may also comprise a printed circuit board (“PCB”). A printed circuit board is a device that may be used to support mechanically and to connect electrically, electronic components using conductive pathways, tracks or signal traces that are etched from copper sheets that are laminated onto a non-conductive substrate. A PCB that is populated with electronic components may be referred to as a printed circuit assembly (PCA), which is also known as a printed circuit board assembly (PCBA). The first rail and the second rail may be attached directly or indirectly to a printed circuit board. By way of a non-limiting example, the first rail and the second rail may each be attached to the printed circuit board by a through-hole screw terminal that is coplanar with (or in a plane that is parallel to) the printed circuit board.

The printed circuit board may be or may not be part of an outlet monitoring device. The outlet monitoring device may be configured to be part of a single port or a multiport outlet monitoring device. A multiport outlet monitoring device may be configured to monitor the output of two, three, four, five, six or more devices.

The printed circuit board may comprise or be in communication with one or more computers that have the necessary hardware and/or software to provide useful information based on the data collected by the printed circuit board. The term “computer” includes any device or network that is configured to execute a series of instructions that may, for example, be contained in hardware, software or a combination thereof. By way of a non-limiting example a computer may comprise a central processing unit, memory, and a portal for communicating with other computers or electronic devices. Technologies using outlet monitoring devices are disclosed in U.S. Patent Publication No. 2010-0070217, which published on Mar. 18, 2010, and U.S. Patent Publication No. 2010-0280978, which published on Nov. 4, 2010, each of the disclosures of which is incorporated by reference in its entirety.

In some embodiments, the cover comprises a first knee stabilization unit and a second knee stabilization unit, wherein each of the first knee stabilization unit and the second knee stabilization unit extends into the interior space from the cover. The first knee stabilization unit is configured to stabilize the first knee and the second knee stabilization unit is configured to stabilize the second knee. Each knee stabilization unit may be oriented perpendicular to the cover.

A knee stabilization unit may comprise, consist of or consist essentially of an electrically non-conductive material such as plastic, rubber or silicone or a combination thereof and be of a size that when the cover and base are engaged it is in physical contact with the knee of the energy leg or less than 2 mm or less than 1 mm away from contacting the knee of the energy leg. In one embodiment, the assembly may be designed such that the knees are always in contact with their respective knee stabilization units. In other embodiments, each knee stabilization unit comes into contact with a knee when the device is plugged into an outlet. The knee stabilization unit may for example be in the shape of a simple rod or other three dimensional structure that emerges from the cover.

An assembly may also be configured to receive a plug from one or more appliances (i.e. an appliance plug). An appliance plug may connect to the assembly through openings in the cover. In some embodiments, one or more appliance plugs each have a pair of blades and a ground pin. Through connectors that comprise, consist essentially of or consist of metal or a metal alloy (e.g. bronze, phosphor bronze, brass or copper), the blades of an appliance plug may be operably coupled directly or indirectly to a printed circuit board that is connected directly or indirectly to the blades of the assembly (or an energy leg) that in turn are connected to the energy source. Similarly, an appliance pin may be put in contact with a receptacle on the earth redirector, which is connected to the ground pin of the earth redirector.

In some embodiments, there may also be a ground pin stabilization unit that extends from the cover and that stabilizes the ground pin of a plug of an appliance. The ground pin stabilization unit may be configured as four sides of a hollow square or rectangle or as a cylinder. Alternatively, it may be another regular or irregular shape that is configured to serve the same purpose. The ground pin stabilization unit may be as long as the ground pin from the appliance or shorter than it and it may be long enough and wide enough to surround all or part of a receptacle for the appliance ground pin and the appliance ground pin when the appliance ground pin is engaged with its receptacle.

The assembly may also contain an earth redirector. The earth redirector may for example have one or two ground pins, each of which is configured to be able to enter an opening in a wall outlet. The earth redirector may also have one or more, e.g., two receptacle units that are each configured to receive a ground pin from an appliance.

According to a second embodiment, the present invention is directed to an assembly that comprises at least one appliance claw, for example two appliance claws for each pair of appliance blades. Each appliance claw has a length, a width and a height, and each appliance claw comprises the following regions: a foot, a spine and a wedge. Each appliance claw may have no axes of symmetry or one axis of symmetry.

The length is the longer dimension that is parallel to the base. The width is the same size as the length or shorter than the length and is also is parallel to the base. The height is the dimension that is perpendicular to the base. In some embodiments, the overall length of an appliance claw is 0.5 to 2 cm, the width is 0.4 to 1.5 cm, and the height is 0.75 to 3 cm. When an appliance claw does not have a uniform length, width or height, the aforementioned dimensions refer to the largest length, width or height respectively.

The foot is configured to stabilize the appliance claw and spans the length and width of the appliance claw. Within the foot may be connection point for communication with the printed circuit board. The foot provides a base for the appliance claw and stabilizes the spine and wedge; it can thereby decrease stress on a printed circuit board. Preferably, it is as long as and as wide as, or longer than and wider than each of the spine and wedge.

The spine extends from the foot. One structure is considered to extend from another if at least one, for example, one, two, three or all sides of a first structure are directly connected to or transition into one, two, three or all sides of a second structure. The difference between two structures may for example be a change in number of sides, change in orientation of one, two, three or all sides or change in continuity or curvature of sides or a combination thereof. For example, moving from one structure to another may correspond to a change from a three dimensional rectangle to a three dimensional triangle, which may happen as one moves from the foot to the spine and wedge. Additionally, the change may correspond to moving from a three dimensional prism in one region in which all three edges are closed to a three dimensional prism in which one edge is open. Alternatively, the change may be from a configuration of three sides of a prism to a configuration that has only two sides of the prism. The different regions may be formed by pressing and molding a single piece of metal or by connecting two more pieces of metals that previously were separate pieces.

In some embodiments, the spine and the wedge may form a regular or modified prism that is open at its top and bottom ends or only at its top end. A regular prism has three flat sides and either three closed edges, or two closed edge and one open edge. A modified prism may be one in which one or more of the three sides contains two or more flat surfaces that have a slight angle between them, e.g., an angle that is greater than zero, but less then 45 degrees or less than 30 degrees or less than 15 degrees or less than 10 degrees, or less than 5 degrees.

The spine extends from the foot, e.g., the foot may be a three dimensional rectangle or, three, four or five sides of a three dimensional rectangle and the spine may be a continuation of one side. The spine has a first height, which refers to the dimension that is coplanar with a side of the base from which it extends. The spine may form a first side of a regular or modified prism, a first portion of a second side of the regular or modified prism, and a first portion of a third side of the regular or modified prism. The first side of the prism may be flat and form edges (rounded or sharp-cornered) with each of the second side and the third side. In some embodiments, the height of the spine is the same over the first side and each of the first portion of the second side and the first portion of the third side.

The wedge is designed to secure an appliance blade and may be formed as an extension of the spine with a greater height than the spine. Thus, the wedge may have a second height, and the first height (the height of the spine) is smaller than the second height (the height of the wedge). These heights may be measured as the dimension that is perpendicular to the base. The wedge forms a second portion of the second side of the regular or modified prism and a second portion of the third side of the regular or modified prism. These second portions extend each of the second and third sides of the spine, but there may be an opening between the second side and the third side where they would otherwise come together in a closed prism. This opening is configured to secure a blade. Thus, there may be a uniform space along the height of the wedge that can expand when subjected to the force of blade being inserted therein and exert pressure on the blade to hold it.

When an appliance is plugged into the assembly, the wedge may expand and tip forward slightly due to the pressure. The spine facilitates this bending forward. When the bending occurs, the wedge may mate with functional divots that may be present on the cover of the assembly. This can prevent push and pull forces from bending the appliance claw an undesirable amount.

Preferably, the foot, the spine and the wedge each comprise, consist essentially of or consist of an electrically conductive material, e.g. bronze, phosphor bronze, copper or brass. Optionally, each appliance claw may be formed from one sheet of metal or metal alloy that is molded or pressed into a desired shape.

As with the first embodiment, in this embodiment the assembly may further comprise a printed circuit board. Additionally, as with the first embodiment, the assembly may comprise a base and a cover, wherein the base and the cover define an interior space. The appliance claw may be completely within the interior space when the cover and base are engaged.

The assembly may also comprise mechanical supports for an appliance claw, which is a claw designed to receive a blade from an appliance, and/or receptacle for a pin from an appliance. The mechanical supports for an appliance claw may comprise a base receptacle socket support and a wedge stabilization unit, each of which extends into the interior space and each of which may be three dimensional tubes or four sides of a three dimensional rectangle or square that extend in the same length-wise dimension, or any other regular or irregular shape that is configured to serve the same function. The base receptacle socket support and the wedge stabilization unit are preferably aligned. Thus, when the cover and base are engaged, the walls of the base receptacle socket support and the walls of the wedge stabilization unit may abut each other or if they don't abut would come into contact if they were longer or at a minimum provide support to the appliance claw without causing it to move to an undesirable configuration.

The wedge stabilization unit may also comprise an additional piece that is configured to stabilize the wedge. This piece may for example be in the form a ledge and be oriented parallel to the plane of the base when the base and cover are engaged. Thus, the wedge may push against the wedge when a blade of a plug is engaged with the wedge. The mechanical supports preferably comprise, consist essentially of or consist of an electrically non-conductive material, e.g., plastic, rubber, silicone or a combination thereof.

The assembly may also comprise an earth redirector. The earth redirector may comprise one or more, e.g., two pins for engaging an outlet, one for grounding and one for stabilization as well as one or more receptacles. The receptacles may also be configured to receive ground pins from an appliance. Further, mechanical supports may be present that partially or completely surround the receptacle for receiving appliance pin when the appliance pin is within that receptacle.

According to a third embodiment, the present invention is directed to an assembly for stabilization of an appliance claw. The features of this embodiment may be used in combination with or independent of the features of the first or second embodiments. The assembly comprises a housing, and the housing comprises a base, a cover and mechanical supports for an appliance claw.

The base and the cover form an interior space and extending from the base into the interior space is a base receptacle socket support and extending into the interior space from the cover is a wedge stabilization unit. The base receptacle socket support and the wedge stabilization unit are aligned, thereby forming the mechanical supports for appliance claws. In some embodiments, the wedge stabilization may be of a height that covers all or covers at least 50%, or at least 70%, or at least 90% of the sides of the wedge. The base receptacle socket supports may be of a height to cover at least 50%, at least 70%, at least 90% or all of the sides of the foot. Although either component of the mechanical supports can be used independently, they are preferably used together. Additionally, although preferably these mechanical supports circumscribe a portion of the height dimension of the base or foot, it is within the scope of some embodiments of the present invention for them to cover only three or two sides of the corresponding structures.

In this embodiment, as in others, there may be more than one appliance claw. For example there may be two or more e.g. four appliance claws. Each appliance claw is configured to receive a blade from an appliance. The blade may be directly or indirectly connected to the appliance. Typically, blades are part of a plug and come in pairs. Similarly, appliance claws may also be arranged in pairs. Also, existing in the proximity of each pair of appliance claws may be a receptacle for receiving a ground pin that is part of a three pronged plug.

In a pair of appliance claws, there may be a first appliance claw, a first base receptacle socket support that extends into the interior space from the base, a first wedge stabilization unit that extends into the interior space from the cover, a second appliance claw, a second base receptacle socket support that extends into the interior space from the base and a second wedge stabilization unit that extends into the interior space from the cover. The first base receptacle socket support and the first wedge stabilization unit may be aligned and the second base receptacle socket support and the second wedge stabilization unit may be aligned. A base receptacle socket support and a wedge stabilization unit are considered to be aligned if when the cover and base of the assembly are engaged an appliance claw's first portion is within or supported by the base receptacle socket support and the appliance claw's second portion is within or supported by the wedge stabilization unit. In some embodiments, when aligned there is no space (i.e. there is contact) or there is less than 0.1 mm or less than 0.2 mm or less than 0.5 mm or less than 1 mm or less than 2 mm between a base receptacle socket support and a wedge stabilization at their closest points along the edges of 1, 2, 3, or all sides.

The base receptacle socket support and the wedge stabilization unit may consist of, consist essentially of or comprise a non-electrically conductive material. The material may for example, be plastic, rubber or a combination thereof.

The assembly of the third embodiment may also comprise a printed circuit board. The printed circuit board may be or may be part of an outlet monitoring device. The outlet monitoring device may be a single port or multi-port outlet monitoring device.

The various embodiments of the present invention may be further illustrated by the accompanying figures.

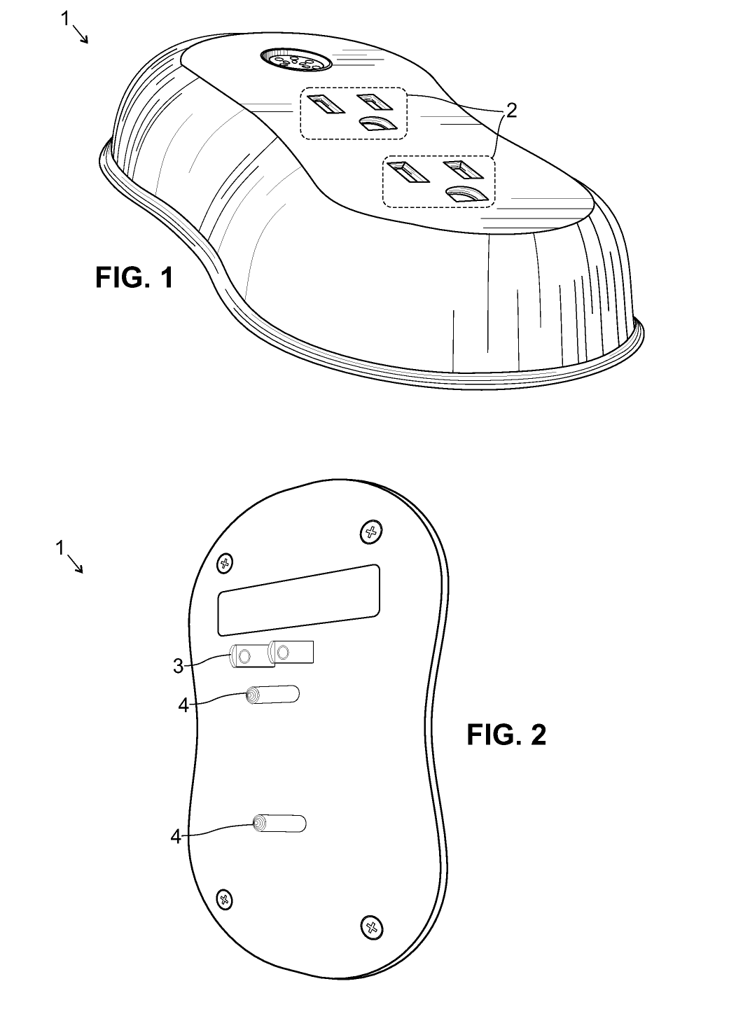

FIG. 1 shows a multi-port outlet monitoring device 1 of the present invention from a front view. The cover and base are engaged and there are openings 2 for the blades and grounding pins of two different appliances. Through the internal circuitry, the use of each of the two appliances can be monitored and analyzed.

FIG. 2 shows the multi-port outlet monitoring device 1 of FIG. 1 from the rear. A pair of blades 3 is shown. The blades are designed to be inserted into a source of electricity, e.g., an outlet. Also shown are two pins of an earth redirector 4. Notably, there are two pins but only one pair of blades. Thus, whereas two appliance plugs can enter the cover of the device through two sets of blades and pins, electricity will flow into the device from a power source through only one set of blades.

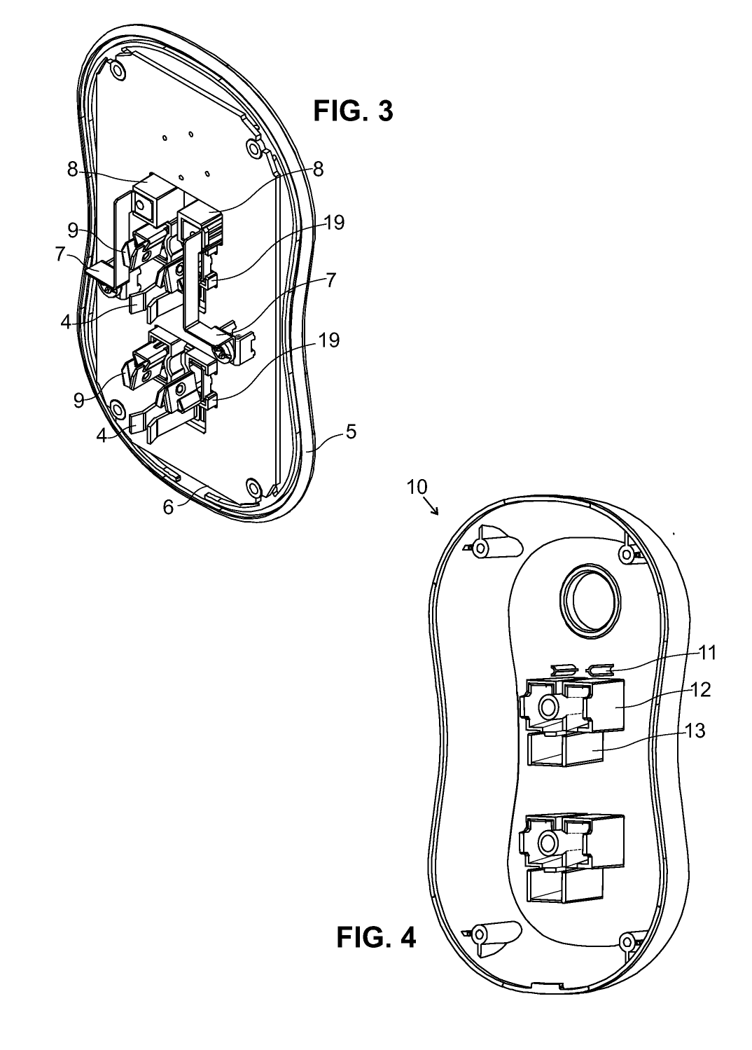

FIG. 3 shows a base 5 of the present invention. In the base is a printed circuit board 6, two energy legs 7, a blade stabilization unit for each energy leg 8, two pairs of appliance claws, 9, a base receptacle socket support 19 for each appliance claw, two receptacle of an earth redirector 4 that are configured to receive grounding pins associated with blades of two separate devices. When in use, electricity travels from the external source through blades, not shown. The blades are stabilized by stabilization units, 8 and the electricity is transmitted across energy leg 7 to the printed circuit board 6. The printed circuit board permits the electricity to travel to the appliance claws 9, which are configured to allow the electricity to move to the blades of an appliance (not shown).

FIG. 4 shows a cover 10 with stabilization components. These components comprise a knee stabilization unit 11 for each blade, a cover wedge stabilization unit 12 for each appliance claw, and a structure to stabilize the receptacle of each earth redirector 13.

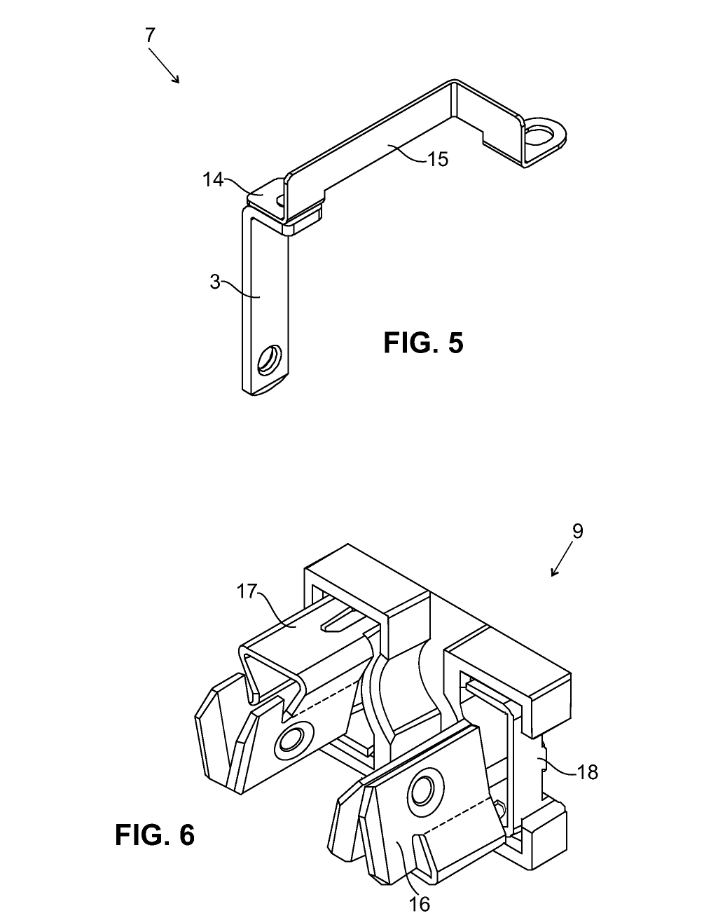

FIG. 5 shows an energy leg 7 that for illustrative purposes is not within any assembly. The energy leg has a blade 3, a knee 14, and a rail 15.

FIG. 6 shows a pair of appliance claws 9. The parts of each appliance claw are a wedge 16, a spine 17 and a foot 18. The appliance claws are oriented in opposite directions, i.e., in the figure, the spine of one appliance claw is closer to the top of the page and the spine of the other appliance claw is closer to the bottom of the page. Each foot is within a base receptacle socket support.

The various technologies of the present invention may be used in combination with any one or more appliances, including but not limited to an air conditioning unit, a heating unit, a computer, an alarm, a television, a radio, a dishwasher, an oven, a stove, or a fan. In an appropriately configured printed circuit board, electricity usage of any appliance that interfaces with it can be monitored and then analyzed by a central processing unit of a computer to determine a signature pattern. The computer may be in wired or in wireless communication with the printed circuited board. Using the analyzed information, during predicted down usage times, electricity can be cut off or decreased.

Through the use of various embodiments of the present invention, one can achieve one or more of superior durability, improved manufacturability and greater cost-effectiveness. Additionally, using the configurations disclosed herein, one can decrease costs of manufacturing.

Unless otherwise specified, any of the features of the various embodiments described herein can be used in conjunction with features described in connection with any other embodiment disclosed. Accordingly, features described in connection with the various or specific embodiments are not to be construed as not suitable in connection with other embodiments disclosed herein unless such exclusivity is explicitly stated or implicit from the context.

We claim:

1. An assembly for stabilization of blades, wherein said assembly comprises:
a. a housing, wherein said housing comprises
i. a base, and
ii. a cover, wherein the base and the cover form an interior space and extending from the base into the interior space are a first blade stabilization unit and a second blade stabilization unit, wherein said first blade stabilization unit and said second blade stabilization unit are comprised of a non-electrically conductive material;
b. a first energy leg, wherein said first energy leg comprises
i. a first blade that has a first portion that extends to an exterior of the housing and a second portion that extends to the interior space, wherein the first blade stabilization unit is configured to stabilize the first blade, and
ii. a first rail that is connected to said first blade at a first knee; and
c. a second energy leg, wherein said second energy leg comprises
i. a second blade that has a first portion that extends to the exterior of the housing and a second portion that extends to the interior space, wherein the second blade stabilization unit is configured to stabilize the second blade, and
ii. a second rail that is connected to said second blade at a second knee.

2. The assembly of claim 1, wherein the first rail is oriented orthogonally to the first blade, and the second rail is oriented orthogonally to the second blade.

3. The assembly of claim 2, wherein the first rail is riveted to the first blade at the first knee and the second rail is riveted to the second blade at the second knee.

4. The assembly of claim 3, wherein the first rail and the second rail are parallel with the base.

5. The assembly of claim 1 further comprising a printed circuit board, wherein the first rail and the second rail are connected to the printed circuit board.

6. The assembly of claim 5, wherein the first rail and the second rail are each connected to the printed circuit board by a through-hole screw terminal.

7. The assembly of claim 5, wherein the printed circuit board is or is part of an outlet monitoring device.

8. The assembly of claim 1, wherein the cover comprises a first knee stabilization unit and a second knee stabilization unit, wherein each of the first knee stabilization unit and the second knee stabilization unit extends into the interior space and the first knee stabilization unit is configured to stabilize the first knee and the second knee stabilization unit is configured to stabilize the second knee.

9. The assembly of claim 1 further comprising an appliance claw and a printed circuit board, wherein the appliance claw comprises:
a. a foot, wherein the foot is configured to stabilize the appliance claw;
b. a spine, wherein the spine extends from the foot and has a first height, and the spine forms first side of a regular or modified prism, a first portion of a second side of the regular or modified prism, and a first portion of a third side of the regular or modified prism; and
c. a wedge, wherein the wedge has a second height, wherein the first height is smaller than the second height, and the wedge forms a second portion of the second side of the regular or modified prism and a second portion of the third side of the regular or modified prism, and there is an opening between the second side and the third side that is configured to secure a blade.

10. An assembly comprising an appliance claw, wherein the appliance claw comprises:
a. a foot, wherein the foot is configured to stabilize the appliance claw;
b. a spine, wherein the spine extends from the foot and has a first height, and the spine forms first side of a regular or modified prism, a first portion of a second side of the regular or modified prism, and a first portion of a third side of the regular or modified prism; and
c. a wedge, wherein the wedge has a second height, wherein the first height is smaller than the second height, and the wedge forms a second portion of the second side of the regular or modified prism and a second portion of the third side of the regular or modified prism, and there is an opening between the second side and the third side that is configured to secure a blade.

11. The assembly of claim 10, wherein the foot, the spine and the wedge each comprise an electrically conductive material.

12. The assembly of claim 11, wherein the assembly further comprises a printed circuit board.

13. The assembly of claim 12 further comprising
a. a base; and
b. a cover, wherein the base and the cover define an interior space; and extending from the base into the interior space is a base receptacle socket support and extending into the interior space from the cover is a wedge stabilization unit.

14. The assembly of claim 13 further comprising an earth redirector, wherein the earth redirector comprises two ground pins and two receptacles.

15. The assembly of claim 12, where in the printed circuit board is or is part of an outlet monitoring device.

16. An assembly for stabilization of an appliance claw, wherein said assembly comprises a housing, wherein said housing comprises
a. a base;
b. a cover; and
c. an appliance claw,
wherein the base and the cover form an interior space and extending from the base into the interior space is a base receptacle socket support and extending into the interior space from the cover is a wedge stabilization unit.

17. The assembly of claim 16, wherein the appliance claw is a first appliance claw, the base receptacle socket support is a first base receptacle socket support, and the wedge stabilization unit is a first wedge stabilization unit, and the assembly further comprises a second appliance claw, a second base receptacle socket support that extends into the interior space from the base and a second wedge stabilization unit that extends into the interior space from the cover.

18. The assembly of claim 17 further comprising a printed circuit board.

19. The assembly of claim 18, wherein the printed circuit board is or is part of an outlet monitoring device.

20. The assembly of claim 16, wherein the base receptacle socket support and the wedge stabilization unit comprise a non-electrically conductive material.
